(19) United States
(12) Patent Application Publication
(10) Pub. No.: US 2015/0323125 A1
(43) Pub. Date: Nov. 12, 2015

(54) Support Assembly

(71) Applicant: Erika Yssel, Alexandria, VA (US)

(72) Inventor: Erika Yssel, Alexandria, VA (US)

(21) Appl. No.: 14/703,850

(22) Filed: May 4, 2015

Related U.S. Application Data
(60) Provisional application No. 61/990,713, filed on May 9, 2014.

(51) Int. Cl. F16M 13/02; H02G 7/00; H02G 3/18; H02G 3/22; F16L 3/015; H02G 3/08

(52) U.S. Cl. CPC F16M 13/022; F16M 13/027; F16L 3/015; H02G 3/081; H02G 3/18; H02G 3/22; H02G 7/00

(57) ABSTRACT

A bracket assembly for connecting a fixture, art-work or other element to a supporting box or structure. The assembly includes a hanger bracket which receives an adjustable post. The bracket may also support quick-connect wire plug-ins for ease in performing wire connections required to operate a fixture such as a chandelier. The adjustable post has spaced recesses that allow for quick coarse adjustment of the post as it passes at an angle through a central interior opening in the hanger bracket. The post is pivoted so that a reinforced rail on the hanger bracket is inserted into a pair of the recesses formed on the post in a snap-fit connection. A threaded portion is also provided at an end of the post for fine adjustment.

### RELATED APPLICATIONS

This application claims priority to and the benefit of U.S. Provisional Patent Application No. 61/990,713 filed on May 9, 2014 the contents of which is incorporated herein in its entirety.

### BACKGROUND OF THE INVENTION

FIG. 1 illustrates a prior art hanging light fixture bracket assembly wherein the fixture 5 is supported on a lowermost portion of a chain 6. The ceiling 16 is provided with an electrical box 1 wherein power is provided to the lighting fixture from household wire 2 such as 14-2 or 12-2 gauge copper wire. It is conventional to weave a stranded wire 12 from the fixture up and through the chain links 6. The uppermost chain link is secured to a solid loop portion 7 of the trim screw 13. The trim screw 13 includes both exterior threads and interior threads (not shown) wherein the interior threads mate with the exterior threads 15 on the hollow hanger screw 9. The hollow hanger screw 9 is threaded into a hanger bracket 4 which is secured to the electrical box 1 via threaded fasteners 10.

To hang the fixture the efficient installer goes up a ladder for the first time with the prior art hanger bracket 4 and fastening screws 10, hollow hanger screw 9, trim screw 13, trim plate 11 and tools to secure the hanger bracket to the electrical box (1; previously installed). The efficient installer should already have the trim screw 13 screwed onto the hollow hanger screw 9. He secures the hanger bracket 4 with screws 10 onto the electrical box. He then screws the hollow hanger screw/trim screw assembly 9/13 into the hanger bracket 4 if he hadn't already done so prior climbing the ladder. The installer adjusts the length of the hanger/trim screw assembly 9/13 relative to the ceiling 16 by continuously twisting the hollow hanger screw 9 into the hanger bracket 4 until the lowermost portion of the trim screw 13 extends just below the opening in the trim plate 11 as the trim plate 11 is seated against the ceiling 16. The installer is checking to make sure a sufficient amount of thread on the exterior of the trim screw 13 is exposed so that a finishing nut 8 can be used to secure the trim plate 11 at the time of final assembly. Once the final threaded position of the hanger/trim screw assembly 9/13 is decided the installer comes back down the ladder with the trim plate 11. What is very important to recognize is that the vertical height of the hanger screw 9 relative to the hanger bracket 4 is critical. It is critical because the installer should strongly avoid rotating the hanger screw 9 after the fixture wires are passed there through. It is common for the stranded fixture wires 12 to fit snugly against the interior surface of the hanger screw 9 as it is threaded there through and thus future twisting of the hanger screw itself also twists the stranded fixture wire 12 leading to the possibility of the stranded wire insulation being torn from the fixture wires or compression of the insulation thus leading to future shorts and inductance spikes. That said, it is well known that twisting of the hanger screw 9 after the stranded wire 12 has been passed there through commonly occurs in the field. A common example is when the light fixture must be rotated to achieve a specific aesthetic appearance or the trim plate is substituted which has less or greater depth. The rotation may happen accidentally when the trim screw is accidentally cross threaded onto the trim screw. See for example FIGS. 3 and 4 of the instant application which show prior art devices as proposed solutions to this well-known problem in the prior art of hanger screw rotation binding wires.

While on the floor the installer now lowers the finishing nut 8 down the chain 6 until it rests against the fixture 5. He follows this with lowering the trim plate 11 down the chain. The next step is for the installer to pick by the chain 6, finishing nut 8, trim plate 11 and fixture 5 together to determine the proper length of the chair. Some installers bring the chain and fixture up the ladder to verify the length. Others use measuring instruments to determine chain length. Once the proper chain length is determined the link at the uppermost position of the chain is opened and the excess chain is decoupled from the remaining length of chain and discarded. With the chain adjusted to a proper length and the uppermost link of the chain 6 opened, the entire assembly is ready to be hung onto the solid loop portion 7 of the trim screw 13. The efficient installer now goes back up the ladder for at least a second time with the chain/fixture. Once he hangs the uppermost chain link onto the solid loop portion 7 he has to bend back the uppermost chain link into its original shape so that its outer diameter is less than the inner diameter of the finishing nut 8 and trim plate 11 which must pass over such at the time of final assembly. It is noted that the installer, while on the ladder, is usually bending this, chain link back into its original shape possibly using two tools thus occupying both his hands. One hand holds pliers that grip the chain link while the other hand holds pliers that grab that portion of the link being bent back into its original position while balancing on a ladder. Optionally the installer may have a replacement link similar to a threaded carabineer that is substituted for the bent chain link which he still must thread while atop the ladder commonly using both hands above his head.

With the chain link bent back into its original shape the installer while still on the ladder, has the next step of weaving the stranded wire 12 through the upper portion of the chain 6, through the opening in the trim screw 13 and up through the hollow hanger screw 9. The installer then has to reach up into the electrical box and gently guide the stranded wire 12, after passing up through the hollow hanger screw 9, over the top of the hollow hanger screw 9 and back out of the electrical box making sure that the top of the hollow screw 9 does not scrape the insulated coating of the stranded wire 12 as it passes there-over. This is commonly the most difficult task of the installer. It is difficult for the installer to get the stranded wire to curl over the top of the hollow hanger screw 9 especially when the screw is adjusted very close to the top of the electrical box 1. Bending the wire over the top of the hollow hanger screw 9 is difficult because there is little clearance between the back of the electrical box and the top of the hanger screw 9 in many instances. It is also difficult because the electrical box 1 may include several household wires if he is connecting several lights together in the circuit. The installer has limited access and sight through restricted openings formed on either side of the hanger bracket 4. The scraping of the insulated coating is the cause of electrical shorts and fires since it is difficult for the installer, who is reaching above his head while on a ladder, to see into the electrical box above the hanger screw 9 while pulling the stranded wire. The installer has a very limited view through the openings formed on either side of the hanger bracket 4 which is secured onto the bottom surface of the electrical box. The installer generally has no option but to use his sense of touch to try to prevent this scraping. The best installer will cut the stranded wire 12 on the floor. The best installer may also choose to strip the stranded wire, meaning peel away the insulation from the ends of the stranded wire for later wire connection, prior climbing the ladder. The best installer would then twist together the stripped ends or use electrical tape to bind them to at in order to more easily guide the stranded wires up and through the interior of the hanger screw 9. Unfortunately even the best installers are not able to add additional electrical tape about that insulated stranded wire portion which is bent over the top of the hanger screw to prevent any scraping because of the high tolerance between the thickness of the stranded wire and the interior diameter of the hanger screw 9. The added thickness of the electrical tape does not fit within the hanger screw 9 and electrical tape has less slip than the insulation on the stranded wire and thus would not allow the stranded wire to pass as easily. It is noted that the electrical tape that is added to the ends of the spliced wire has to be removed while the installer is atop the ladder with his hands above his head in a later step. Likewise he would have to untwist the ends of the spliced wires while atop the ladder with his hands above his head. Thus most installers choose to cut the stranded wire 12 only after it is threaded through and over the hanger screw 9 and pulled out of the electrical box 1. Thus, the installer must bring a wire cutter and/or stripper with him up the ladder.

The vast majority of installers only do a rough cut of the stranded wire 12 on the floor and then do a final cut of the length of the stranded wire 12 while atop the ladder after determining the proper length after it is passed through and over the hanger screw 9. The vast majority of installers are thus trimming the end of the insulation away from the stranded wire 12 while atop the ladder and with both their hands above their head while looking up. The stranded wire 12 must be long enough to allow for wire-nut connections 3 generally outside the electrical box 1. On the other hand the stranded wire 12 should not be left so long that it is difficult to fit it all safely within the electrical box or behind the trim plate. A longer stranded wire 12 makes it easier to connect the wire nuts since the installer does not need to reach as far above his head when making the connections. And if the radius or dimension of the chandelier is large than the installer is going to likely use a large length of household wire leads and fixture leads because he may have great difficulty even reaching the electrical box without assistance.

While still on the ladder the installer must now pull out the household leads 2, which are normally 14 gauge, and connect each to the respective stranded wires 12. While still reaching over his head he must securely connect the respective leads with respective wire nuts 3 and possibly also add electrical tape for added safety. The electrical tape is highly recommended in that it is well known that wires of differing gauges do not helix together for the highest quality connection. A wire nut is designed primary for helix connections. However, stranded wire is commonly must thinner and less dense than solid gauge 14 conductor wire. And since they are of different gauges the wires do not helix as they are twisted. When twisting occurs the stranded wire will tend to move-up and circle the solid gauge wire. The installer must use experience to recognize when the wire nut is properly bound to the solid gauge wire. It is the electrical tape that adds the extra measure of safety just in case the wire nut is not properly bound. Again, this requires two hands while the installer is balancing himself atop a ladder so the vast majority of installers in the field fail to use electrical tape and rely solely on the wire nut to secure the connections. One hand is holding the household wire 2 while the other hand is twisting the stranded wire 12 about the household 2 prior the wire nut 3 mechanically securing the pair together. This can even be more precarious and take more time atop the ladder if the installer has not already stripped the household wire in preparation of this step. As the installer pulls the household wire/leads 2 from the box 1 he has to be careful to not strip any of the insulation from the household wire due to edges formed by the hanger bracket 4, which is also metal, as the wires are being pulled out of the box for connection purposes through the openings formed on either side of the hanger bracket 4. It is not uncommon for an installer, especially when the finishing plate 11 is shallow thereby requiring the hanger screw 9 to be raised relatively close to the back of the electrical box 1, to have to cut the length of the hollow hanger screw 9 to provide adequate clearance. Of course in doing so he must be careful to file any sharp edges from the uppermost end of the cut hanger screw 9 to avoid the stranded insulation being torn as discussed prior. This is especially critical in that, as discussed above, electrical tape cannot be added to the outside of the stranded wire for added protection due to limited space within the hollow hanger screw 9 and thus the only protection from sharp edges is the wire insulation itself. The installer has to also be careful, if he has to cut the hanger screw 9, not to damage the threads in that clean threads are needed to readily screw the hanger screw into mating threads on the hanger bracket 4. This, of course, adds more time to the installation project as well.

The next step is for the installer, with the wires now secured together by wire nuts 3 and possibly electrical tape, is to re-insert all the wires back into the electrical box 1 without kinking any of the wires or bending them severely thus causing a heating point. The benefit of having space between the wires and thus stagnant air is that the stagnant air acts as an insulator. Thus an electrical box 1 overly crowded with household wires and stranded wires raises the risk of an electrical hazard. The amount of wire pushed back into the electrical box 1 is not consistent with every installation. The amount of wire pressed back into the electrical box 1 is highly diverse in the field based on the personal decisions of the installer. Just as the use of electrical tape to secure the wire nuts, household and stranded wire together is limited and inconsistent. It is limited because adding electrical tape takes extra time to perform the task. It further requires extra items to be carried up the ladder such as the tape and cutters and the task of wrapping the tape around the wire nuts has to be performed above the installer's head with both hands extended. The installer is the one choosing the length of stranded wire and likely the final length of the household wire that was only roughly cut in preparation of the final installation of a fixture. Just as the installer is choosing whether to add the electrical tape which is beneficial. The final step of the installer, once the wire is positioned properly in the electrical box 1, is to raise up the trim plate 11 and to press such to the ceiling 16 by screwing the finishing nut 8 onto the trim screw 13. Given this conventional in it is clear that an extensive amount of time is spent by the installer atop a ladder with his hands generally raised above his head while working.

FIG. 2 illustrates a prior art light fixture that is secured directly to the hanger bracket 18. In this instance the installer, while up on a ladder, must somehow support the entire light fixture 19 while he is making wire connections. The household wires 21/22 must be connected to the respective light fixture stranded wires 23/24 before the light fixture can be secured in place up against the ceiling. With the installer on a ladder the respective wires must be secured together while taking caution not to drag the wires against the metal bracket 18 to avoid tearing the insulative sheath of the wires. With the wire connections made the installer must return the connected wires and wire nuts into the electrical box.

Since the installer is atop a ladder he is unlikely to perform the added safety measure of putting electrical tape about the end of each wire nut and connected wires because of both fatigue and instability atop the ladder. As with the chandelier installation discussed regarding FIG. 1, the installer must be careful not to kink the wires, pinch the wires or bend such severely thus causing a heating point. Once again the benefit of having space between the wires and thus stagnant air is that the stagnant air acts as an insulator. An electrical box 29 overly crowded with wires raises the risk of an electrical hazard. The next step of the installer, once the wire is positioned properly in the electrical box 29, is to raise up the light fixture 19 and to secure such to the ceiling by screwing the finishing post 36 onto the hollow screw 27. At this point the installer can no longer see the position of the wires hidden behind the light fixture plate 25. Lastly the light fixture glass dome is held in place by securing such to the light fixture plate 25 by screwing the finishing nut 36A onto the threaded end of the finishing post 36. Even with this flush mount fixture it is clear that an extensive amount of time is spent by the installer atop a ladder with his hands generally working above his head while he simultaneously supports the light fixture and performs several tasks. Such tasks include having the installer screw in the hollow screw 27 to the proper length, connect the wires with wire nuts, optionally put electrical tape about the wire nuts, tucking the wires properly atop the fixture plate 25, screwing the finishing post 36 onto the hollow screw 27 once the light fixture is pressed against the ceiling and retaining the glass dome with the finishing nut. The benefits of the instant invention are many and include ensuring that the stranded wires are placed in locations that are not directly atop the bulbs as in this prior art configuration. Wires that are directly above the bulbs can deteriorate at a faster rate due to the drying of the insulative sheathes thereby raising the risk of fire.

FIG. 3 is illustrative of a prior art device as shown in U.S. Pat. No. 6,653,558 wherein the mounting bracket includes a leaf spring 17 which allows the hollow hanger screw 20 to be pushed into the mounting bracket without the need to screw the hollow hanger screw 20 into the mounting bracket 26. As noted prior, repeated twisting and adjustment of the hanger screw is a well-known problem in the field. The entire support of the fixture relies on the leaf spring 17 properly engaging the threads of the hollow hanger screw 20. It is not clear how the trim plate 28 can be consistently held firm against the ceiling with such an arrangement wherein any rotation of the fixture relative to the electrical box would cause the wiring to twist which is extremely hazardous.

FIG. 4 is illustrative of a prior art device as shown in U.S. Pat. No. 6,824,298 wherein a chandelier can be supported by a slotted hanger bracket 30 by a double-nut arrangement. It is noted that the hanger bracket 30 is severely weakened by the slot that is created to allow the hollow hanger screw 31 to be slid onto the hanger bracket 30. The purpose of this prior art invention was to avoid needing to twist the hollow hanger screw 31 onto the bracket 30 with stranded wire tightly fit therein. As noted prior, it is very hazardous to cause twisting of the stranded wires within the hanger screw and this is a well-known problem in the field. As noted prior, this occurs commonly when the installer makes a hanger screw length adjustment to fit the trim plate more tightly against a wall or ceiling surface.

FIG. 5 is illustrative of a prior art arrangement as shown in US 2013/0292149 wherein there is a plug device that passes through the hanger bracket for a wall mounted fixture. This prior art device requires a plug device 32 with a wire bundle of at least three leads that are passed through the hanger bracket 33 and respectively secured to the household wires with wire nuts. This also adversely adds additional wires into the electrical box. The length of the wire bundle also limits the amount of space that the installer has to work. For example, if the wire bundle is short as well as the household wire then the installer will have to work very closely to the wall surface to connect the wire bundle leads and household leads together while supporting the bracket assembly, it is noted that in this prior art device that the installer must awkwardly support the entire bracket assembly while at the same time make each of the wire connections. It is only after the wire connections are made does the installer then secure the bracket to the electrical box. The fixture is provided with an adjoining plug 34 which fits into plug device 32. It is assumed that in this prior art device the producer would manufacture the light with the plug 34 otherwise a significant amount of time is added to the installation by wiring in both a first plug 32 into the electrical box and then wiring another plug 34 onto a standard fixture. It is noted that given the mounting bracket 33 that the prior art solution was to pass the wires through the bracket versus around the bracket when a plug-in device was desired. Of course it is also noted that the mounting bracket 33 did not include the conventional central threaded opening for a hollow hanger screw and that this design is limited to wall-mounted fixtures. By passing the wire bundle through bracket, the bracket itself is weakened and the rotation of the brackets relative to each other more that approximately 100 degrees relative to each other before the wires interfere with the rotation. Also, this design does not limit the edge of the innermost bracket from engaging the wire bundle and possibly cutting wire insulation from the bundle of wires.

FIG. 6 is illustrative of a prior art arrangement also shown in US 2013/0292149 wherein there are provided multiple plugs 210 secured in openings 216 in a plate 201 that is part of a two-part mounting bracket. The second part of the mounting bracket includes a support bracket 204 which includes bolts 218 onto which a wall mounted light fixture is attached. The support bracket can swivel about screw 206 relative to the plate 201 by means of a slot 209 wherein the screw 208, when tightened, holds the plate 201 fixed relative to the bracket 204. A two part mounting bracket is conventional for wall mounted fixtures. The slots 217 are provided through the plate 201 to secure such to an electrical box The problem with the plugs 210 is several fold. One is that they are easily releasable when an installer presses hard to insert a wire. There is not adequate structure that prevents the plug 210 from popping out of the opening 216. A second issue is that the plugs must be relatively tall given this vertical design and thus would not work with a shallow electrical box. A third is that such large openings 216 weakens the bracket. A fourth is that this design adds a significant amount of wires into the electrical box wherein three plugs 212 would add at least 9 wires into the electrical box to then be secured to the household wires. A fifth is that if these adapters 210 are used for unsheathed wires that the brackets 201/204 remains ungrounded. A sixth is that this mounting bracket does not include a central opening to secure a post that is used to secure a fixture to a surface. This prior art device requires that the fixture be secured to the bracket via the pair of fasteners 218.

FIG. 7 is illustrative of a prior art flush mount fixtures shown in U.S. Pat. No. 6,653,558 which includes spring elements 37 which are press fit into a hanger bracket 38 and includes ratcheted teeth 39. In order to release such a fixture from the electrical box an opening would be required through the fixture for insertion of a tool. Those openings would allow heat from the fixture to pass up into the electrical box and thus dry the wires over time. Alternatively the screws 40, which hold the spring elements to the fixture, would have to be removed overhead followed by the springs 37 being squeezed to release the ratcheted teeth 39.

The benefit of the instant invention over this prior art is several fold and includes reducing the amount of time it takes to perform an overall installation of a wall or ceiling mounted fixture, artwork or other element onto a vertical surface or a horizontal surface. Indeed an installer of a ceiling light fixture using the instant invention can proceed up a ladder for the second and final step without a single tool to complete the installation. The instant invention eliminates delays such as those caused by damaged threads when hanger screws need to be cut in length. The invention reduces the amount and type of hand motions that have to be performed such as eliminating the repetitive hand twisting motion of a hanger screw which is known to lead to joint injury in comparison to prior art. The instant invention has the substantial benefit of reducing installer injury and fatigue by limiting the amount of time it requires to perform an installation, it reduces the number of tasks to complete the installation and it reduces the number of tools an installer has to carry. At the same time the instant invention makes for a safer installation by reducing the risk of electrical hazards, and thus increasing safety, by providing a repeatable method and system wherein wire lengths are more consistent and the risk of scraping insulation is totally eliminated. As an example, the installer will no longer choose whether to use electrical tape or not after securing a wire nut since a wire nut is no longer needed. And in addition, if the installation is off the floor this invention greatly reduces the amount of time that an installer is on a ladder and very importantly limits the amount and type of hand motions that the installer has to perform with hands above the head while balanced atop a ladder.

### BRIEF DESCRIPTION OF THE DRAWINGS

FIG. 1 is an illustration of a prior art conventional chandelier support assembly.

FIG. 2 is an illustration of a prior art conventional overhead ceiling fixture.

FIG. 3 is an illustration of a prior overhead fixture with a hanger bracket including a leaf spring.

FIG. 4 is an illustration of a prior art slotted hanger bracket.

FIG. 5 is an illustration of a prior art electrical connection that passes through a hanger bracket of wall mount bracket.

FIG. 6 is an illustration of prior art electrical plug-in clips mounted on a conventional wall mount two-piece hanger bracket.

FIG. 7 is an illustration of prior art overhead lighting fixture which uses a ratcheted spring clip to in the fixture.

FIG. 8 is an illustration of a perspective top view of a referred embodiment.

FIGS. 8A-8C are side views of a hanger bracket.

FIG. 9 is an illustration of a perspective bottom view of a preferred embodiment of the invention.

FIG. 10 is an illustration of a bracket and post with the electrical connectors removed.

FIG. 11 is an illustration of a hanger bracket showing rein rail and ramp portion.

FIGS. 11A-11F are illustrations of a hanger bracket.

FIGS. 11G-11H are illustrations of a hanger bracket and post assembly.

FIG. 12 is an illustration of an adjustment post.

FIG. 13 is an illustration of a perspective bottom view with fixture wires passing through a fine adjustment portion.

FIG. 14 is an illustration of a perspective of the electrical connectors on a hanger bracket.

FIG. 15 is an illustration of the electrical connector and how they are formed to slide onto hanger bracket.

FIGS. 15A and 15B are illustrative of hanger bracket and wire connector assemblies.

FIG. 16 is illustration of a perspective view of a ground wire connector.

FIG. 17 is illustration of a cross section of a ground wire connector showing the path of a conductor within an insulated housing.

FIG. 18 is an illustration of a cross section of the neutral and hot lead wire connectors showing the paths of conductors within insulated housings.

FIG. 19 is an illustration of some adapters that may be used to connect thinner stranded fixture wires to a wire connector.

### DETAILED DESCRIPTION OF THE PREFERRED EMBODIMENTS

The present invention can be understood more readily by reference to the following detailed description, examples, and claims, and general discussion in the background of the invention. Before the present devices and/or methods are disclosed and described, it is to be understood that this invention is not limited to the specific structure or orientation of the devices and/or methods disclosed unless otherwise specified, as such can vary. It is also to be understood that the terminology used herein is for the purpose of describing particular aspects only and is not intended to be limiting. Those skilled in the relevant art will recognize that any changes can be made to the aspects described, while still obtaining the beneficial results of the present invention. It will be apparent that some of the desired benefits of the present invention can be obtained by selecting some of the features of the present invention without utilizing other features. Accordingly, those who work in the art will recognize that modifications and adaptations to the present invention are possible and can be desirable in certain circumstances and are a part of the present invention. Thus, the following description is provided as illustrative of the principles of the present invention and not in limitation thereof.

Additionally, as used herein, relative terms such as “substantially”, “generally”, “about”, “approximately”, “proper clearance”, “essentially” and the like, are utilized herein to represent an inherent degree of uncertainty that may be attributed to any quantitative comparison, value, dimension, measurement, or other representation. These terms are also utilized herein to represent the degree by which quantitative representation may vary from a stated reference without resulting in a change in the basic function of the subject matter at issue. The singular “a”, “an”, and “the” include plural references unless the context clearly indicates otherwise. Also, the use of “or” means “and/or” unless stated otherwise. In the drawings, like numbers refer to like elements. Also, it is understood and applauded that the installer referred to in this application could be either gender and that the selected use of the terms “he/his” are used in this application to represent both men and woman equally.

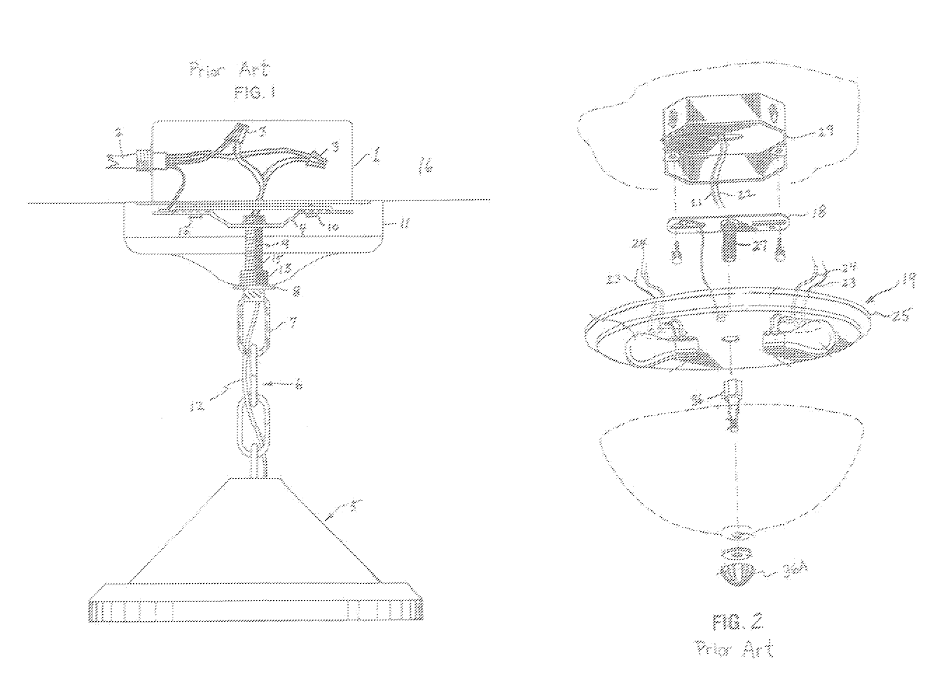

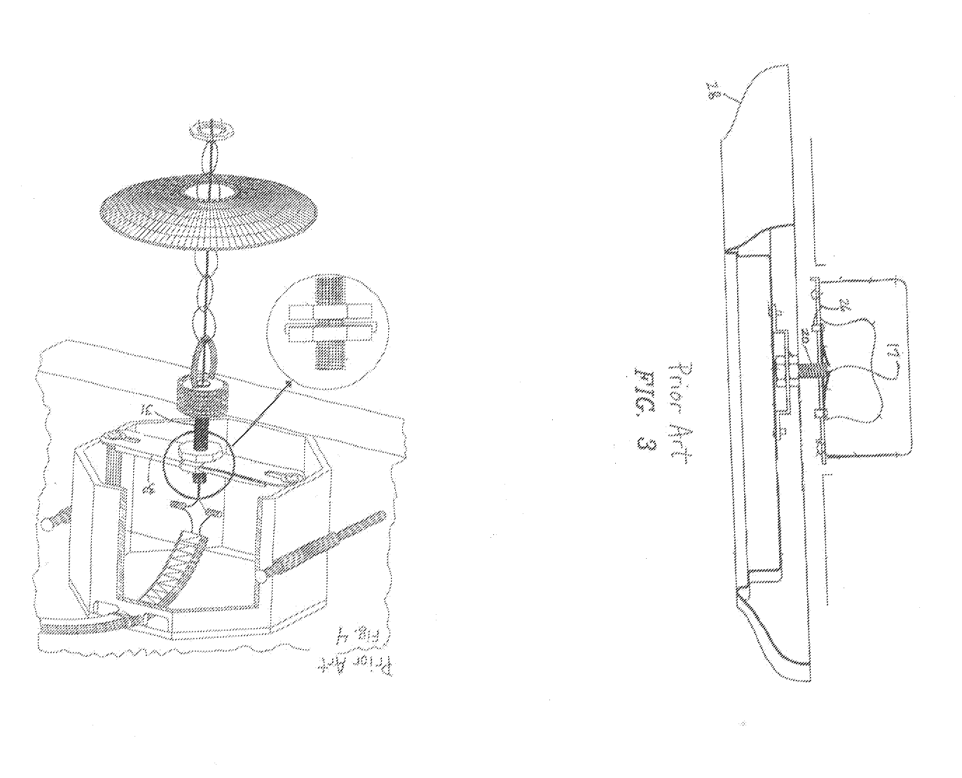

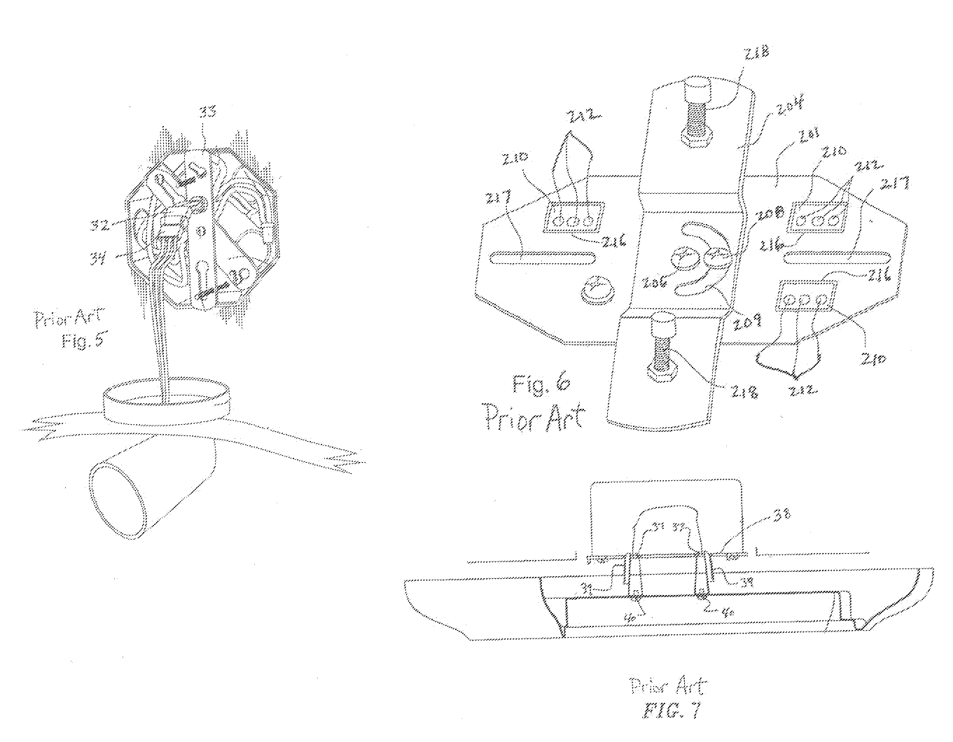

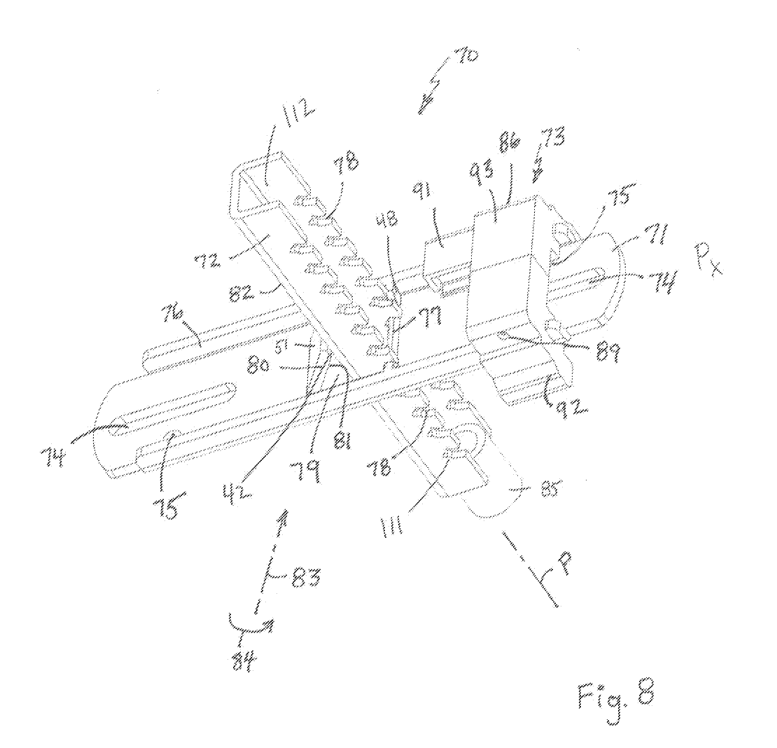

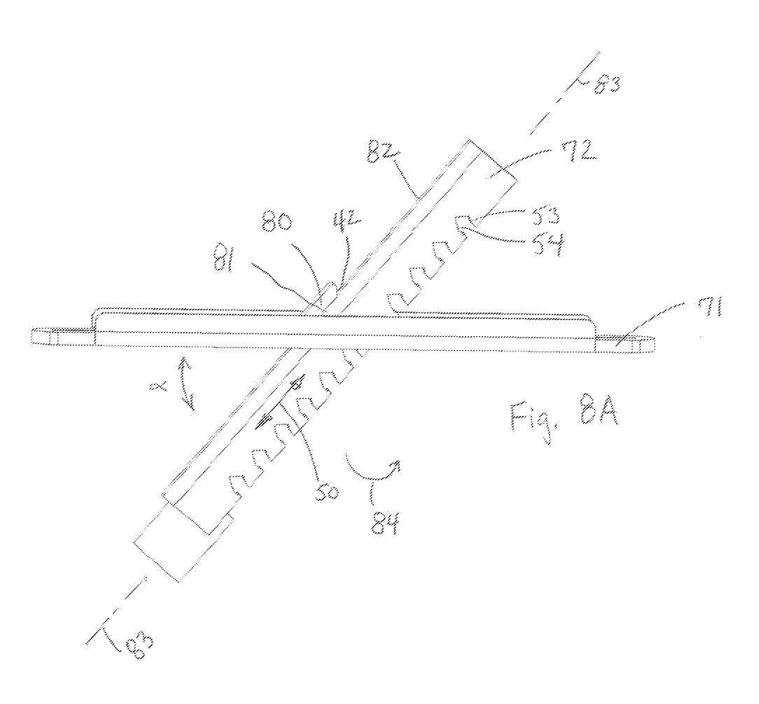

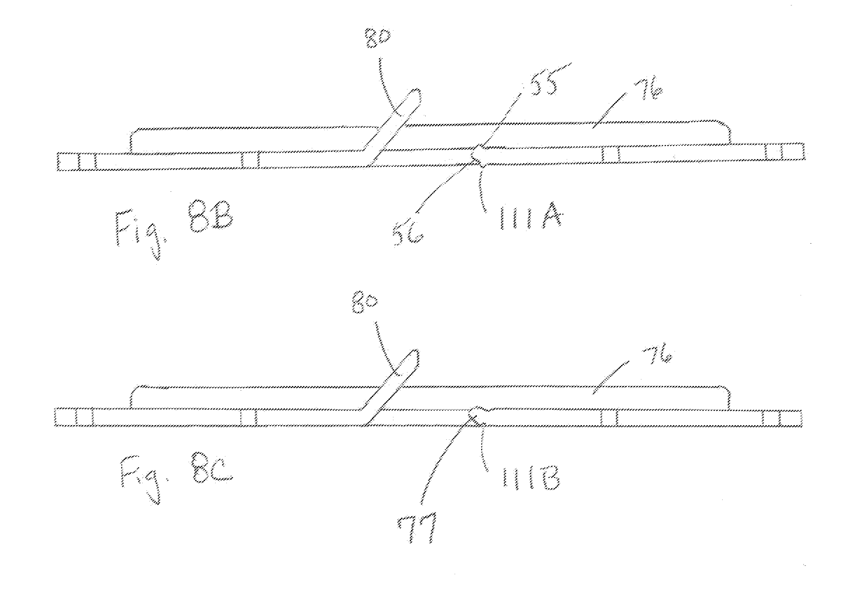

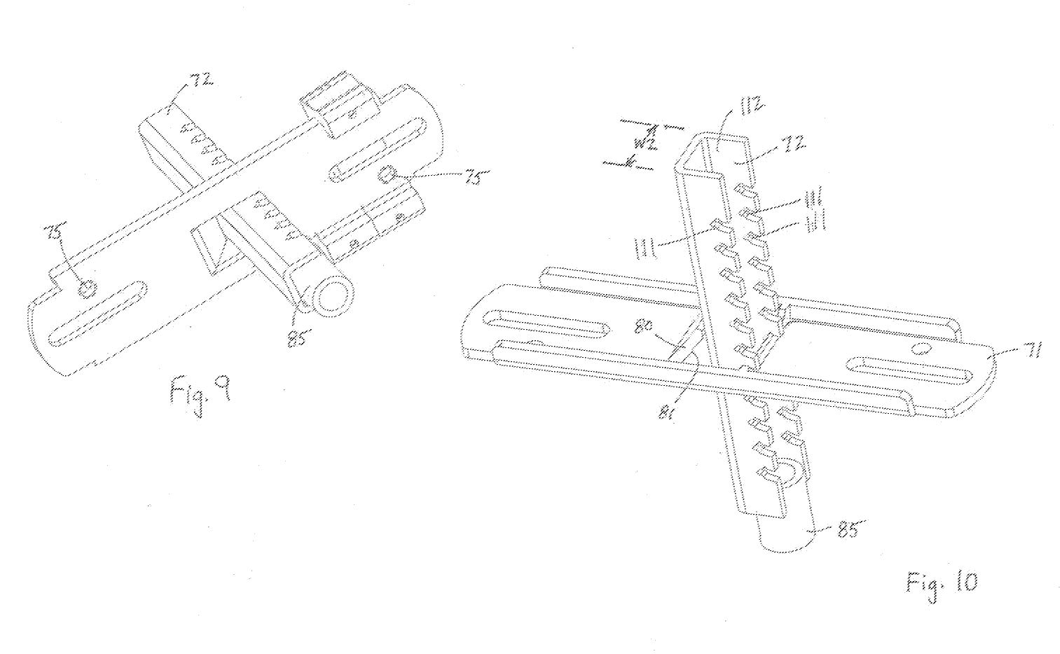

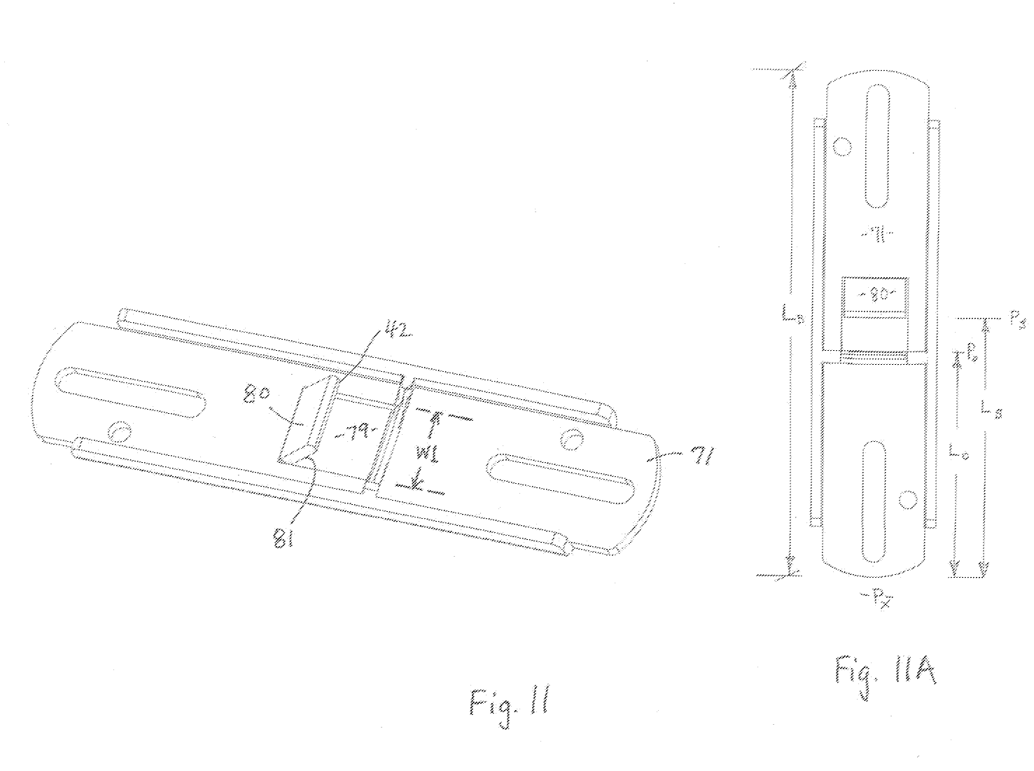

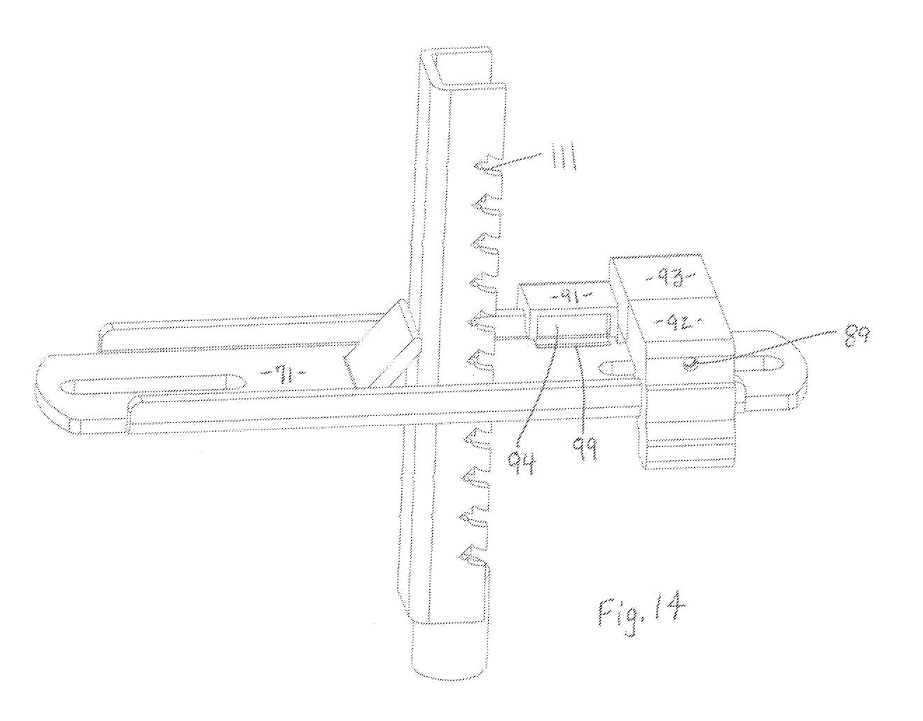

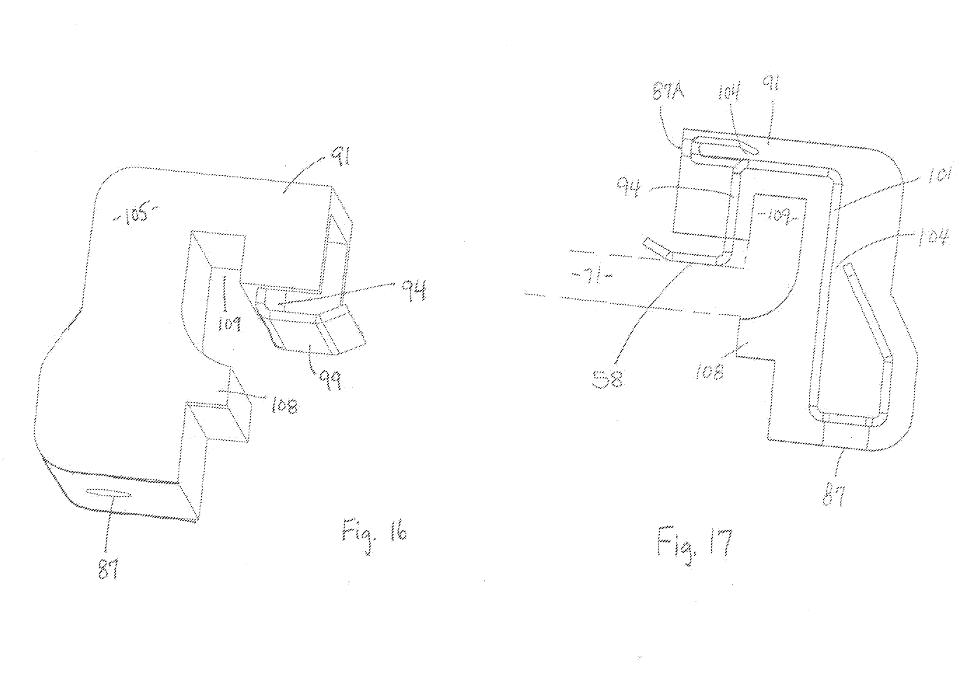

FIG. 8 is illustrative of a preferred embodiment of a support assembly being used to support a ceiling fixture. The assembly 70 generally includes three elements or components in combination including a support bracket 71, an adjustment post 72 (vertically oriented when used on a ceiling) and electrical connectors 73. The electrical connectors 73 are formed at least in part including portions of non-conductive or electrically insulative material, such as plastic, and enclose or encase electrically conductive elements which form the electrical path between an external conductor such as household wires and the external conductors of a light fixture as discussed hereinbelow. The support bracket 71 may include reinforcement ribs or walls 76 along each side of the bracket and may also be formed essentially flat without ribs. Further shown are openings, apertures or, as illustrated, slots 74 which receive the fasteners (not shown) that attach the support bracket 71 to a ceiling electrical box (e.g. 1; FIG. 1 or 29; FIG. 2). The support bracket 71 may include a pair of threaded openings 75 for a ground screw (not shown). The ground screw is connected to the bare ground of the household wiring (2; FIG. 1). The ground loop passes between the ground screw, through the metal support bracket 71, and the metal rail or conductor 94 (FIGS. 14, 17) via the contact surface/location 58 (FIG. 17) of the electrical ground clamp 91 and with the fixture via the fixture bundle ground wire, discussed hereinbelow. The conductor 94 at contact location 58 also provides a ground loop path when armored cable is attached to a metal electrical box as discussed hereinbelow. The support bracket 71 may further include a reinforced rail or stiffening member 77. The stiffening member may include a pair of portions or elements 48 that extend from a central portion of the stiffening member 77 to each respective rib 76 to structurally tie the stiffening member to the ribs. A portion of the stiffening member 77 is formed in cross section to interlock with the recesses 78 of the adjustment post 72. When the adjustment post 72 is interlocked with those portions of the reinforced rail 77 there is a snap-fit connection as discussed further detail hereinbelow.

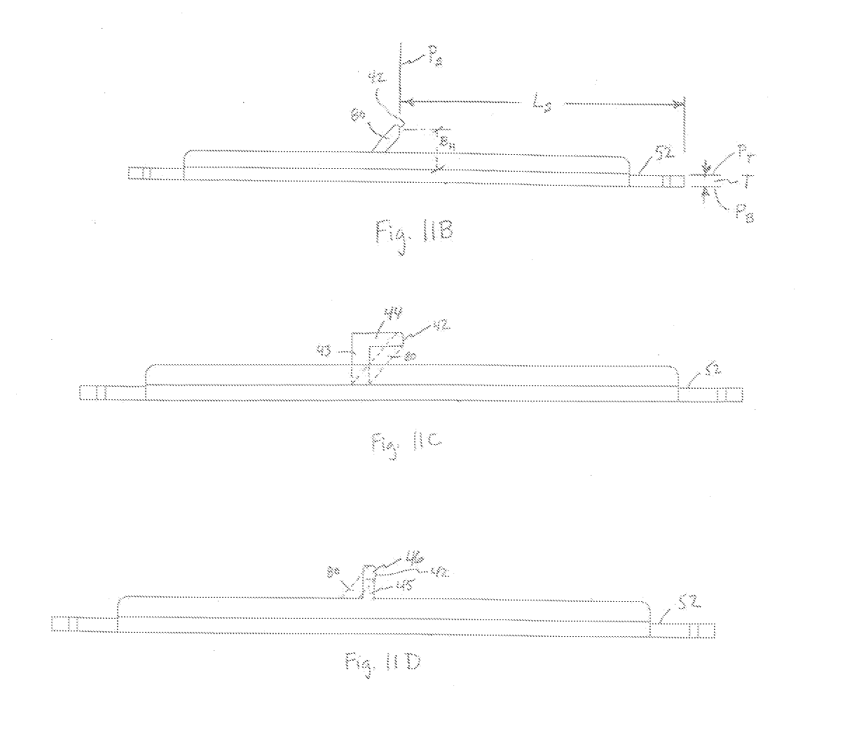

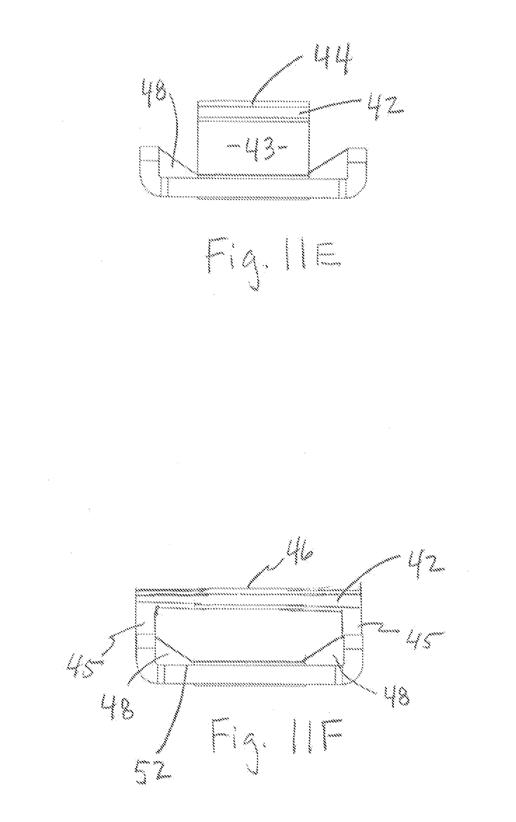

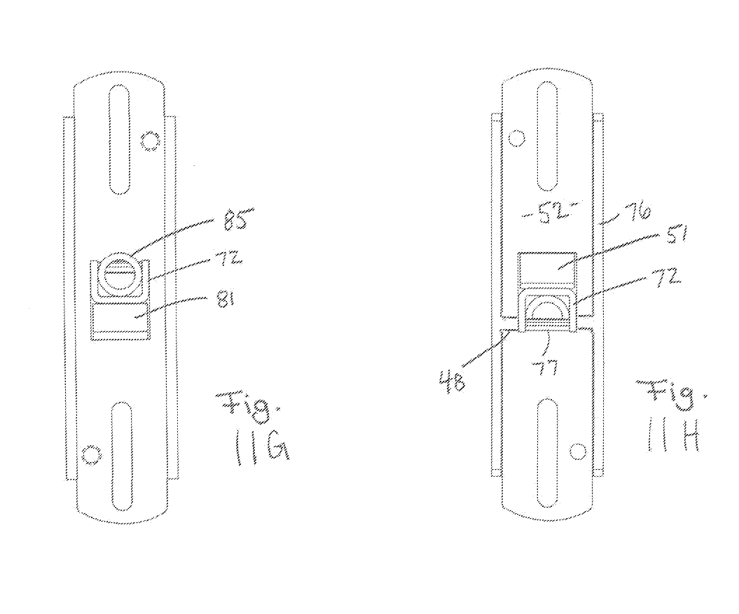

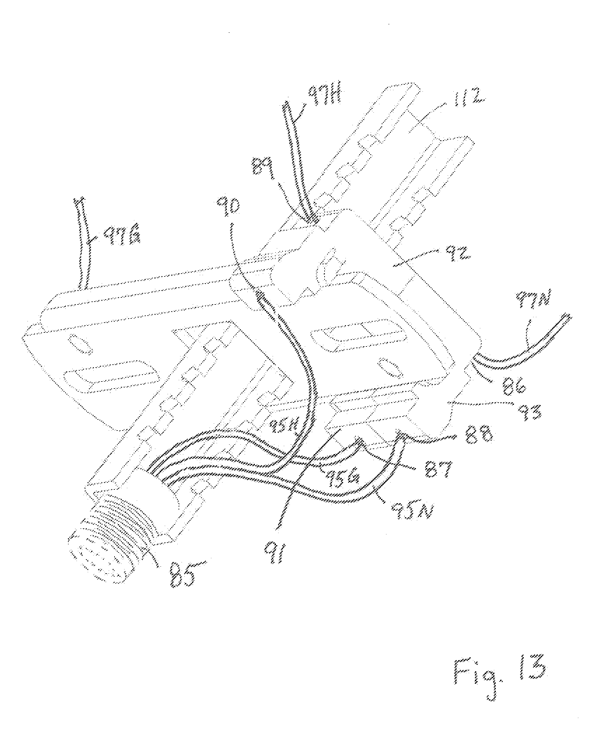

The support bracket 71, as shown in each of FIGS. 8-11 is formed with an opening 79. In a preferred embodiment the opening 79 is rectangular or square in shape but it can have various shapes without departing from the scope of this invention. In the preferred embodiment the bracket is made of metal and the opening 79 is fixed by removing the metal to form the opening. It should be noted that the opening 112 of the adjustment post is facing (FIG. 8) the end of the bracket where the wire connectors 91-93 are located, in this manner the fixture wires (FIG. 13) will not be subject to additional bending about the post 72 as they pass through the cylindrical or tubular element of the fine adjustment portion 85. The stiffening member 77 may extend along one side of the opening 79 and further extend to each respective rib 76 thereby acting as a beam to support the adjustment post 72. The stiffening member may also be in two segments with each segment being located at either end of the side of the opening wherein each segment engages a recess 78 on the post 72 without departing from the scope of the invention. The opening 79 has a width W1 (FIG. 11), along which the stiffening member 77 extends, that is slightly larger than the width W2 (FIG. 10) of the adjustment post 72 to allow for adequate clearance for the adjustment post 72 to slide smoothly longitudinally therethrough (e.g. along axis 83 as shown by arrow 50 in FIG. 8A) but allow essentially no twisting of the adjustment post about its longitudinal axis P (FIG. 8). The adjustment post 72 is first installed through the opening 79 along the angled axis 83 (FIGS. 8, 8A). In the preferred embodiment of the assembly of FIGS. 8 and 8A the angled axis 83 is parallel to the bottom surface 81 of a ramped portion 80 of the support bracket 71 and formed at an acute angle a to the bottom surface of the hangar bracket 71 (FIG. 8A). The back surface 82 of the adjustment post 72 slides along the bottom surface 81 in parallel relationship as the post 72 is inserted through the opening 79. The top surface of the ramp being shown at 51. By aligning a selected recess 78 with the reinforced rail 77, the adjustment post 72 is then pivoted or rotated counter-clockwise (as viewed in FIGS. 8, 8A by arrow 84) until the respective recess 78 interlocks with the reinforced rail 77 ending in a snap connection by a mechanical interlock, as discussed hereinbelow. The recess 78 is configured with arcuate surfaces 53/54 (FIG. 8) that are guided over arcuate surfaces 55/56 (FIGS. 8B, 8C) formed on the reinforced rail or ledge or beam 77 to allow rotation or pivoting of the adjustment post 72 about such the rail or ledge or beam 77. The adjustment post 72, as it is being locked in a vertical position for coarse adjustment, will be prevented from being rotated further counter clockwise as shown in FIG. 8) beyond vertical by the back surface 82 of the post 72 engaging a stop surface 42 at the end of the ramped portion 80 which acts as a stop. Thus the stop surface functions to limit the angle of rotation in the counter clockwise direction as illustrated in FIG. 8. The post 72 will further be held by the interlocking of the reinforced rail or stiffening member 77, which acts as a support ledge or beam, with a pair of recesses 78. Once locked in place in the vertical, position (e.g. when supporting a chandelier) the post 72 requires an additional effort to unlock the post.

It is noted that one of ordinary skill in the art can form the stop surface 42 using various physical structures such as those shown in FIGS. 11A-11F. The stop surface 42 is designed to be at a location relative to the bracket 71 to both allow the adjustment post 72 to pass through the opening 79 and prevent the post, once the beam 77 is inserted into a recess 78 of the post, to rotate beyond a designed or set angle of approximately ninety degrees. The result being that the longitudinal axis P of the post being transverse to the plane of the bottom or top surface of the hanger bracket 71 as illustrated in each of FIGS. 8, 9, 10, 13 and 14. The stop surface is designed to be a distance L_{S} from the proximate end P_{X} of the bracket as shown in FIG. 11A. The opening 79 is designed to begin at a set distance L_{O} from the proximate end of the bracket. The distance L_{S} being greater than L_{O} and the difference therebetween providing the space for the adjustment post 72 to extend as illustrated in the respective top and bottom views of FIGS. 11H and 11G, respectively. The length L_{S} is approximately half the length L_{B} of the overall bracket as illustrated in FIG. 11A but could be designed at various distances along the bracket length L_{B}. The stop surface 42 is further designed to be a height above the bracket B_{H} as shown in FIG. 11B. The preference is to have the center line P of the post aligned with the center of the electrical box so that the trim plate properly is centered about the electrical box.

As shown in FIGS. 11A through 11F, the stop surface can be formed at the end of various structures or stop elements without departing from the scope of this invention. Such structures or elements include a ramp 80 as shown in FIGS. 11A and 11B as well as in phantom in FIGS. 11C and 11D FIGS. 11C and 11E illustrate that one of ordinary skill in the art could design a “L”-type structure resulting in the stop surface 42 being in the same location as a ramp structure. The “L”-type structure is shown to have a riser leg or legs 43 as well as a transverse leg or legs 44 ending at the stop surface 42. FIG. 11C is a side view wherein FIG. 11E is a front view of the L-type structure. The riser 43 could extend vertically from the reinforcement ribs 76 or from the top surface 52 or from both. The riser leg could be formed by more than one solid element as illustrated. Although the riser is illustrated as extending transverse to the bracket it is understood that it could also be configured at angles other than ninety degrees without departing from the scope of this invention. Similarly the transverse leg 44 could be formed by more than one solid element FIGS. 11D and 11F are illustrative of an inverted “U”-type bracket that extends with risers 45 from the reinforcement ribs and being connected by a cross-member 46 wherein the cross-member includes the stop surface 42. As illustrated in FIG. 11D the cross-member could be designed to be located at the same location as that of the ramp stop surface without departing from the scope of this invention. The risers 45 could extend vertically from the reinforcement ribs 76, as illustrated, or from the top surface 52 or from both.

A snap-fit connection between the recess 78 and reinforced rail 77 requires additional effort on the part of the installer to overcome the mechanical snap fit. The snap-fit connection is formed by having a slight depression or indent in each respective recess 78 (not shown) that receives a slight projection 111A (FIG. 8B) formed on the reinforced rail 77. Alternatively, the rail 77 could have a slight depression or indent 111B (FIG. 8C) while the recesses 78 have slight projections (111; FIGS. 8, 10 12, 14). It is the inter-fitting or frictional engagement or mechanical deformation of the slight projection 111/111A with the slight depression or indent 111B that causes the mechanical fitting that is described as a snap-fit. It is described as a snap-fit in that the installer will feel the additional effort needed to both lock the adjustment post 72 in the generally transverse position and to unlock the post 72 from the generally transverse position. The snap-fit connection adds a solid feel to the post to resist any movement once the post 72 is adjusted into its generally transverse position relative to the support bracket 71 and also functions to maintain that positional relationship. This interlocking or snap-fit connection is an additional benefit if the bracket is installed on a generally vertical surface for a wall-mounted fixture or structure as discussed hereinbelow.

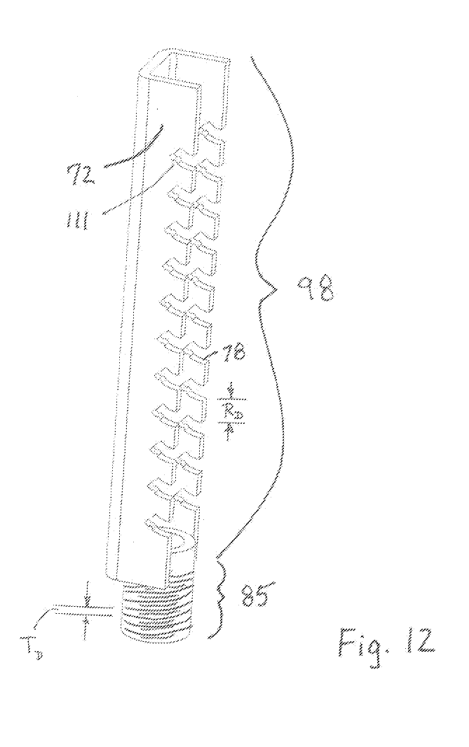

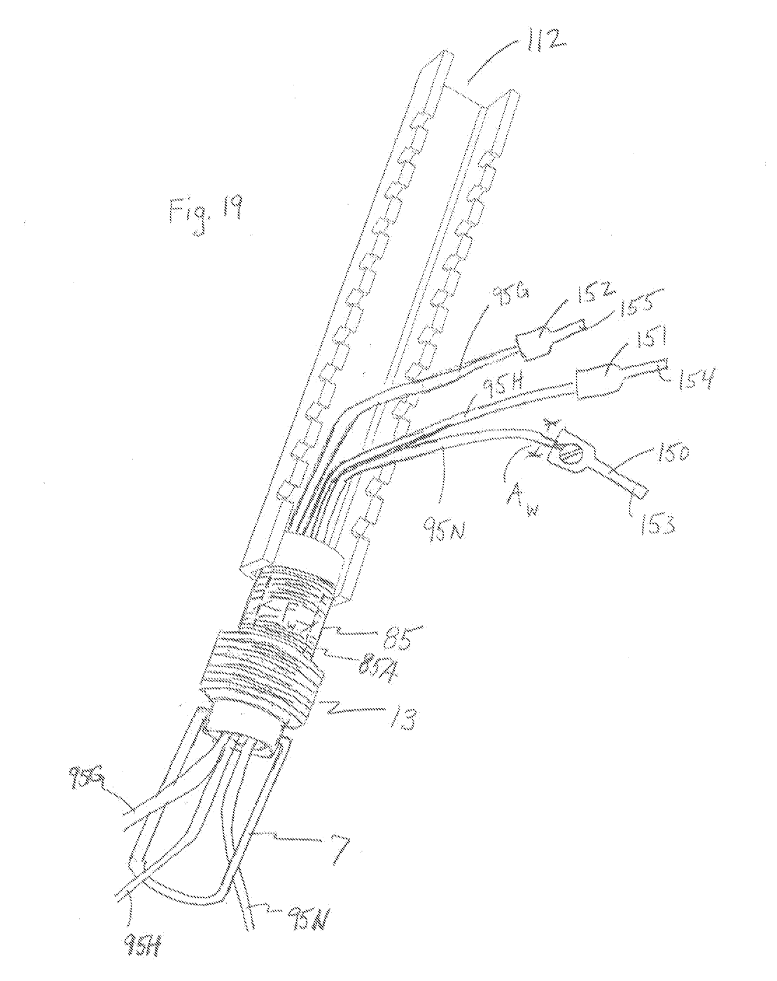

As can be seen in each of FIGS. 8-10 and 12 the adjustment post is actually comprised of two portions. The first upper portion is the coarse adjustment portion 98 which comprises an open-sided element which acts as the platform for the support of a structure, such as a chandelier or other fixture. It is a coarse adjustment portion in that the distance R_{D} (FIG. 12) between successive recesses 78 is relatively great in comparison to the distance T_{D} of the thread pitch of the exterior thread portion found on the fine adjustment portion 85, in the preferred embodiment the distance R is at least 10 times greater than said distance T_{D}. The second lower portion is a fine adjustment thread portion 85 that as a preferred embodiment is in the form of a hollow cylinder or tube with exterior threads fixedly secured to the coarse adjustment portion 98. It is noted that the fine adjustment portion may be formed of a structure other than a cylinder such as a four sided tubular element wherein the threads can be located on the four exterior corners of the tubular structure without departing from the scope of the invention. The fine adjustment portion 85 includes exterior threads (FIGS. 12, 13, 19) to accept a trim screw (13; FIGS. 1, 19). The trim screw 13, as discussed with respect to the prior art devices hereinabove, has both interior threads to thread upon the threads of the fine adjustment portion 85 and exterior threads to accept the threads of a finishing nut 8. As in the prior art assemblies the finishing nut 8 would secure a trim plate 11, 25, 28 to a wall surface such as a ceiling 16. Tensile load from a hanging fixture is transferred via a trim screw 13 which is threadably secured to the threaded fine adjustment portion 85, then through the coarse adjustment post 98/78 to the reinforcement rail 77, which is formed integrally with the hanging bracket and to the electric box 1 which is secured to the ceiling via fastening screws 10 interposed through the slots 74 of the hanger bracket 71.

There are multiple benefits to having the coarse adjustment portion 98 of the adjustment post formed with an open side. One such benefit is that it allows the wires from the fixture (FIG. 13) to pass through the hollow cylindrical or tube portion 85 of the fine adjustment portion and into an open channel (112; FIG. 10) formed by the three-sided coarse adjustment portion 98 to be readily grasped by the installer since the hollow cylindrical portion 85 is relatively short. This can be seen in FIG. 19 wherein the fixture wires 95N, 95G, 95H are passed through the cylindrical portion 85. The channel 112 allows the installer to readily see the wires as they pass through the cylindrical or tubular portion 85. A second benefit is that the open side allows the respective ground 95G, neutral 95N and hot lead 95H from the lighting fixture to be readily plugged into the plug-fit holes 87, 88, 90 of each of the respective wire connectors as discussed hereinbelow without the need of the installer to reach into the electrical box or to pull any wires around any metal edges as in prior art devices. In this manner the installer completely avoids any concern of kinking the fixture wires 95G, 95N, 95G or cramming the fixture wires and household wires 97G, 97H, 97N (FIG. 13) back into the electrical box. There is no longer a need to use wire nuts to attach the household wires to the fixture wires. This system avoids any sharp edges that may tear the insulation of any of the wires as discussed hereinabove. There is also no risk of fire or short due to twisting stranded fixtures wires within the narrow hanger screw as in prior art devices. The installer, at the time of securing the hanger bracket 71 to the electrical box, has already plugged the respective household neutral lead 97N into the plug-fit hole 86 and the respective household hot lead 97H into plug-fit hole 89. The household ground wire is connected to the screw (not shown) that fits into ground screw hole 75 to ground the entire assembly. Alternatively, the ground wire connector 91 can include a plug-fit hole 87A for the household ground wire thus alleviating the need for the ground screw. The ground screw (not shown) is located at the same end of the hanger bracket 71 as that of the electrical connectors 91,92,93 wherein the head of the ground screw is located at a position to act as a stop after the electrical connectors 91,92,93 are slid onto the hanger bracket 71 during assembly. Alternatively, the bracket 71 can be formed with a slight protrusion from the to surface 52 causing an interference fit with the wire connector to hold the wire connectors in place. Alternatively the ground screw could be replaced with a press-fit in made of plastic with a head portion that acts as a stop. Various other connections can be made between the wire connectors and bracket such as the use of an adhesive instead of or in combination with the stop pin/screw without departing from the scope of the invention. This arrangement prevents the wire connectors 91-93 from sliding off the hanger bracket 71 during shipping or during installation wherein the bracket may be attached to a vertical surface for a wall-mounted fixture, device or structure and thus be vertically oriented. The path of ground will pass through the contact 94 (FIGS. 14, 16, 17) via the contact surface 99 of the ground connector with that of the hanger bracket 71 and to the light fixture as discussed hereinbelow.

A third benefit is that the installer can readily cut the top end of the adjustment post off thus reducing the size of the coarse adjustment portion 98 when the electrical box is either filled with household wires or is found to be shallow without the worry of tearing wire insulation or damaging threads. Since the fixture wires 95G,95H,95N do not pass over the top edge of the adjustment post (FIG. 13), as in the prior art hanger screw design, there is no risk of tearing the insulation on the wires 95G, 95N, 95H associated with the light fixture. In fact electrical tape can be added across the top of the coarse adjustment post 72 very easily at any time for added safety, if there is any concern that the post may engage household wires within the electrical box. The opening 79 is dimensioned to allow for the thickness of at least two layers of electrical tape about the sides of the post 72 and still allow for smooth passage of the post 72 through the opening 79. This is to allow installers to add electrical tape to the top of the post especially if the post is cut just in case the electrical box 1. is crowded with wires that the top of the post may engage. All edges of the post are manufactured with smooth rounded or non-sharp edges. A fourth benefit is that the three sided portion is easily grasped, slid, rotated and snap-fit into place in one smooth motion to a proper adjustment length with ease and speed while atop a ladder. The prior art conventional hollow threaded hanger screw 9/27 required proper threading onto the hanger bracket and then turning of the hollow threaded screw in a continuous manner to adjust it until the installer was confident it was at the proper length to bring the trim plate tight against the finishing surface such as drywall. It was this repetitive twisting motion of the prior art hanger screw that has led to wrist injury and stiffness of finger joints.

A fifth benefit is the elimination of all the excess wires the electrical box wherein now the lighting fixture leads are sealed within the trim plate of the light fixture itself which also acts to seal the electrical box. The trim plate also sealed the electrical box in the prior art fixtures but generally all the wires were still forced back into the electrical box itself including wire nuts as discussed in the background of the prior art hereinabove. Since the installer, in the prior art systems, arbitrarily decided on the length to cut the fixture wires there was never a consistent system to determine the final length of wire that was forced back into the electrical box. By over-filling the electrical box the risk of electrical hazard increased. The over-filled electrical box further limited the installer's ability to see each of the wires and thus determine if any wire was kinked or stripped of insulation or even if a wire nut had come loose. The instant invention does not introduce new wires into the existing ceiling electrical box and thus preserves the stagnant air, which is sealed by the trim plate of the fixture, to act as an insulator against any fire. A further benefit of having the coarse adjustment portion 98 of the adjustment post being open or three sided is that it can function in both a vertical orientation as well as a horizontal orientation. In the horizontal orientation, with the open channel 112 facing generally downward, the post will be prevented from rotation by the back surface 82 of the post 72 engaging the stop surface 42, and the interlocking of the reinforced rail 77 and recess 78. If the open channel 112 is facing generally upward, the snap-fit connection of e,g. the rail 77 having a slight depression or indent while the recesses 78 have slight projections (111; FIGS. 8, 10, 12, 14), as discussed hereinabove, is sufficient to hold the post 72 in place until the finishing nut 8 (as discussed in prior art devices) is screwed onto the fine adjustment portion 85 of the post securing the fixture to the wall surface.

The instant invention is not only safer but it makes installation faster. In the past the installer had to cut the household wire 2 with enough length to pull it down from the electrical box 1 and through the openings formed between the prior art hanger bracket and the electrical box. This step has been totally eliminated. He would then need to strip the ends of the fixture wire 12 so that he could twist the fixture wire about the household wire 2 at a later time, while atop a ladder for a chandelier installation with wire nuts 3 securing the two together. Any stripping of the fixture wires is now done on the floor and there is no longer any twisting of the fixture wire to the household wire. This is very beneficial since these wires are of different gauge as was discussed hereinabove wherein a helix connection is not formed. Of course he was pulling the fixture wire and household wire through the opening with his hands above his head while atop the ladder. In contradistinction with the instant invention the installer merely quickly plugs the respective household wire leads 97N (neutral) and 97H (hot) into the plug-fit holes 86 and 89 and screws the ground wire 976 onto the ground screw which is threaded into the hanger bracket in a threaded opening at 75. Alternatively, the wire connector 91 for the ground connection could also include a plug-fit hole 87A in lieu of using the ground screw. With all the household wires installed in the wire connectors the installer now screws the hanger bracket 71 into the electrical box and thus is readily prepared for the next step of checking the coarse adjustment length of the adjustment post 72. The installer never has to reach into the electrical box 1 again. The installer doesn't even need wire nuts any longer. The importance of this cannot overstated. There have been numerous injuries from this step alone which is now eliminated. In the past the installer, while atop the ladder, had to reach down into his tool belt pocket to grab the proper sized wire nuts. This sudden eye movement of looking down and re-focusing caused installers to become unbalanced and thus fall from ladders.

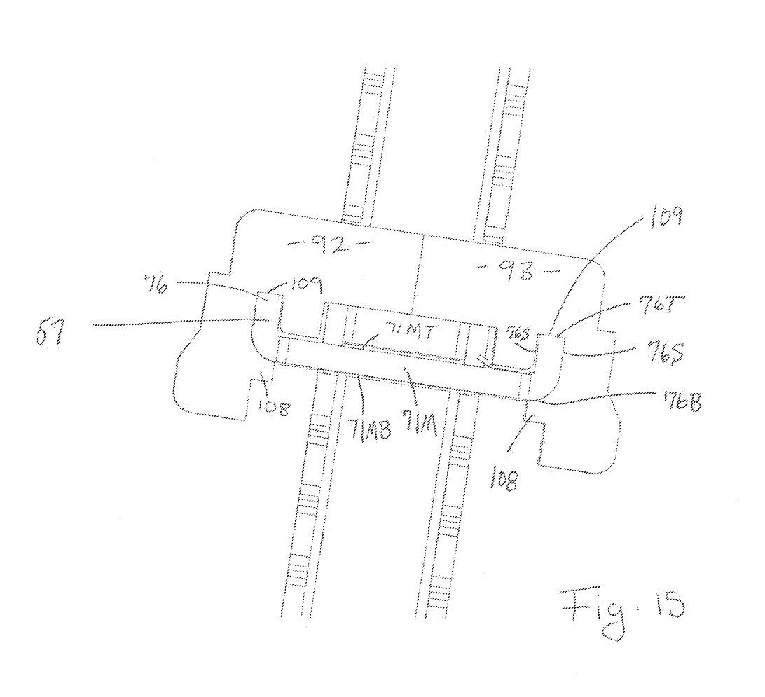

FIG. 14 is a perspective view of the three wire connectors. The wire connectors 91, 92, 93 are each formed of insulated shells which house respective metal strips or conductors. The wire connectors can be formed as one assembly or as separate units. The wire connectors each insulatively enclose or encase respective wire conductors 101/94. The assembly or units of wire connectors 91-93 are formed to slide onto the hanger bracket 71 from either end of the hanger bracket. This is shown in FIG. 15 wherein a cross sectional configuration of the hanger bracket is illustrated. The hanger bracket has a main body portion 71M that has a top surface 71MT/52 and a bottom surface 71MB. A preferred embodiment of the hanger bracket also includes reinforcement ribs 76 formed integrally on either side of the main body portion 71M to stiffen the bracket. The ribs 76 include a rounded bottom surface 768 that extends from the main body portion 71M. The ribs further include inner and outer side surfaces 765 and a top surface 76T. The connectors are designed in cross section to include portions which inhibit the installer from readily causing the release of a wire connector from the hanger bracket as he presses a wire firmly into any plug-fit hole. For example, the projection portions 108 (FIGS. 15-18) are formed on the wire connectors beneath and in juxtaposition to a bottom surface 71MB/76B of the main body portion and/or side rib to prevent separation of the wire connectors from the hanger bracket due to vertical load for a ceiling installation) as the installer pushes the fixture lead into a respective plug-fit hole e.g. 87, 88, 90. The recesses 109 are formed at the end of slots 57 and are in juxtaposition to a top surface 76T of the reinforcement rib 76 (FIG. 15) to also prevent separation and twisting and function to guide the wire connectors 91, 92 93 as they are slid along the longitudinal axis L_{B} of the hanger bracket.

The wire connectors are also formed in juxtaposition to the side surfaces 76S of the ribs as shown in FIG. 15. The wire connectors are formed with a general cross section of the hanger bracket so that load applied from any of the top, the sides or the bottom cannot readily separate the wire connector from the bracket yet at the same time allow for the sliding motion of the wire connector along the hanger bracket. The wire connector is designed to have at least two surfaces in juxtaposition to the hanger bracket. One such surface may be where projection portion 108 is in juxtaposition to the bottom surface of the main body and/or rib portion 76B and the second surface may be where the wire connector is in juxtaposition to a top surface 76T of the hanger bracket. FIG. 15A illustrates an embodiment of a bracket 71 wherein the wire connectors 92A and 91A are formed as separate units without departing from the scope of this invention. As separate units the wire connectors 92A and 91A are designed such that they can each slide generally the entire length of the bracket 71 and avoiding any interference with the structure of the post or stop surface. The cross section of each unit 92A and 91A has a general cross section of the hanger bracket meaning they essentially mimic portions of the bracket as seen in FIG. 15A. The utility of this design is that it inhibits the formed wire connectors from being separated from the bracket 71 as different forces are being applied to them e.g. when force is added as use wires are pressed into the plug-fit holes in either the top or side surfaces of the wire connectors and wire fixture wires are pressed into the plug-fit holes in the bottom surface of the wire connectors.

The plug-fit holes can be included on any surface of the wire connectors but the preferred embodiment is to have the household wire plug-fit holes 86, 89 configured to be on the respective wire connector surface or surfaces that face the back of the electrical box (top surface) or a side surface of the wire connector. The preferred embodiment is further to have the fixture wire plug-fit holes 87, 88, 90 being formed on the lowermost surface of the wire connector such that it is readily seen and accessible to the installer after the bracket 71 is secured to the electrical box 1. This location of plug-fit holes also makes it intuitive to the installer where the household wires should be plugged and where the fixture wires should be plugged. This has a further utilitarian benefit if the attachment mechanisms, for securing the wires to the conductors within the wire connectors, used in the respective holes differ because of wire gauges. Although the wire connectors are properly labelled there is a benefit to designing the wire connector to function in an intuitive manner. The instant invention may also include wire connectors wherein each housing may be produced in a different color. This has the utilitarian benefit of reducing wiring errors and shortening installation time since plug-in connections will immediately be recognized. The hot lead housing is formed in black. The neutral lead housing is formed in white and the ground lead formed either in green or brown. FIG. 15B shows an embodiment wherein the bracket 71A does not include reinforcement ribs without departing from the scope of this invention. The bracket 71A includes wire connectors 928 and 938 that are formed with inner slots 57 which essentially mimic the outer surface or cross sectional shape of the hanger bracket 71A. The plug-fit holes 86, 88, 89 and 90 are shown in phantom and can be located on any surface without departing from the scope of this invention. Each wire connector 92B/938 is formed so that it can slide onto the bracket and be secured thereto without additional hardware and can be held to the bracket 71A with other connections such as the use of an adhesive instead of or in combination with the stop pin/screw or protrusions, as discussed hereinabove, without departing from the scope of the invention.

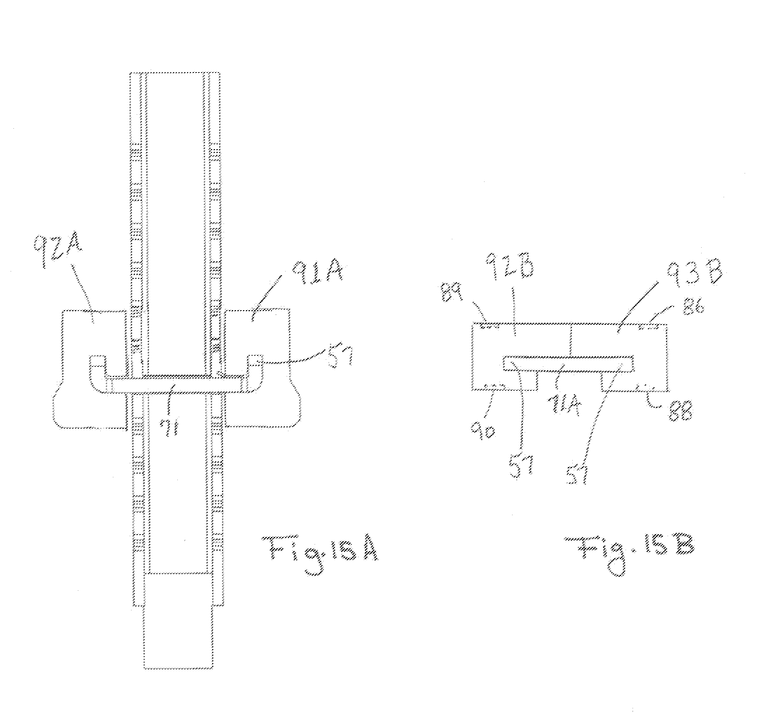

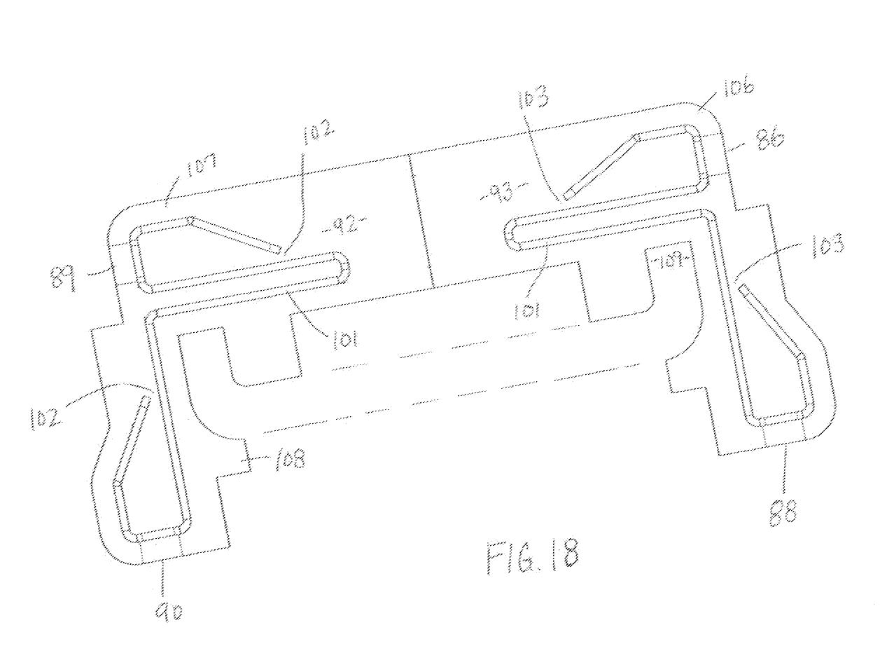

The ground connector 91 includes a metal strip or conductor 94 inside the insulated shell 105 (FIG. 16) that has an exposed contact surface 99 external to the housing or shell of the wire connector which engages the hanger bracket 71 (FIG. 14) thus allowing the ground loop to act through the metal hanger bracket 71. This is especially utilitarian when the ground loop is passed along the metal shield of armored BX electrical cable wire. As is well known a ground loop will travel from the metal shield of the cable wire to a metal electrical box 1 by securing the metal shield directly to the metal electrical box by contact. The ground loop then travels through the metal bracket 71 which is in contact with the metal box 1 via clamping by the fasteners 10. The conductor 94, being in direct contact with the metal bracket 71, forms a path for the ground loop to travel to the fixture via the contact location 58. Alternatively the ground connector 91 could have a plug-fit connection 87A for the household ground (FIG. 17) located preferably on a top or side surface and still have a contact element 94 to directly ground the hanger bracket at 99. In this manner the ground loop would extend proximate the first opening 87A and extend via the conductor 101 proximate the second opening 87 to form a first electrical path and include a branch 94 that forms a conductive path to the bracket 71 as shown in FIG. 17 to ground the bracket and, if the electrical box 1 is metal, also the electrical box. The ground connector 91 is shown in cross section in FIG. 17 wherein the metal strip or conductor or wire 101 includes a clamping or securing or fastening point 104 for the fixture wire which is inserted through the plug-fit hole 87. The clamping point preferably is a one-way lock-type arrangement which prevents the release of the respective wire or wires unless a pulling and/or twisting motion is applied. Alternatively a release port could be added on the wire connector without departing from the scope of this invention allowing an installer to insert a tool to release the wire from the clamping location. The neutral wire connector 93 is in juxtaposition with the ground wire connector 1 and also includes an insulated shell 106 (FIG. 18) as well as a metal conductor strip or wire 101 that provides conductivity between the fixture wire 95N and the household wire 97N after each are respectively inserted into the respective plug-fit openings 88 and 86. The hot wire connector 92 is located opposite the neutral wire connector 91. This arrangement is intuitive to a skilled installer by maintaining the neutral and ground leads next to each other but on an opposite side from the hot lead. The utilitarian benefit of this is that it keeps the opposed charged wires furthest apart thereby reducing the possibility of a short circuit as is understood by those skilled in the art. The hot wire connector includes an insulated shell 107. The neutral and hot wire connectors 92, 93 are shown in cross section in FIG. 18 wherein the respective metal conductive strips 101 can be seen. The wire conductor 101 extends from proximate each opening respective household wire opening 86/89 and extends to proximate the fixture wire opening 88/90. Each of the metal strips or wires 101 clamp the respective wires at clamping points 102, 103. The instant invention will provide greater safety for the installer in that he will spend less time atop a ladder, stop repetitive hand twisting motions, and it will provide greater safety for the home or business in that the risk of electrical shorts or heat build-up is greatly reduced by eliminating such actions as overstuffed electrical boxes, torn wire insulation and loose wire nuts as in prior art devices.

To secure a hanging fixture, such as a chandelier, in accordance with a preferred embodiment of the invention the efficient installer goes up a ladder for the first time with the hanger bracket 71 assembly including the respective wire connectors 91, 92, 93 mounted thereon, fastening screws (not shown), a wire stripper (if the household wires were not stripped prior) and a tool (screwdriver) to thread the fastening screws e.g. 10 to secure the hanger bracket 71 to the electrical box 1. As noted hereinabove, the ground screw is to be screwed into the bracket 71 only if a plug-in connection 91 for the household ground wire is not used. It is noted that the installer does not need to bring wire nuts or electrical tape or any other wire cutting tools if the household wire is already cut and stripped in the ceiling electrical box. Also, it is very important to understand that the installer does not need to bring the coarse adjustment post 72 up the ladder as he is only needing to plug the respective household wires 2 into the hanger bracket respective wire connectors 91, 92, 93 and secure the bracket 71 to the ceiling electrical box (1; illustrated in FIG. 1). While still on the ground the efficient installer has already adjusted the position of the post 72 by pivoting and snap-fitting the coarse adjustment post 72 into place in the central opening 79 of the bracket 71. The position of the coarse adjustment post 72 is based on the depth of a custom trim plate (as illustrated in FIG. 1 as element 11) that was purchased with the light fixture. The installer will position the post 72 such that just a small amount of the fine adjustment portion 85, which includes exterior threads (85A; FIG. 19), extends through the lowermost opening of the trim plate (11) for screwing on a finishing nut (as illustrated in FIG. 1; element 8) as is well known in the art. With the proper position determined, the installer then marks the exact pair of recesses 78 that he will use when he actually re-attaches the coarse adjustment post 72 to the bracket 71 and secures the light fixture assembly to the bracket, as discussed hereinbelow. Thus, the installer limits the amount of time needed atop the ladder in this first step by performing most of the necessary steps on the ground as will be further explained hereinbelow. It is also noted that if the installer fails to mark the recesses in the first step that a quick adjustment is readily made in the second and final step that will not twist the fixture wires as in the prior art devices. The installer will merely need to un-snap, slide, reposition and snap-fit the post in a different set of recesses.

While atop the ladder the installer screws the household ground wire 97G onto the ground screw such that the bare ground wire 976 is now supporting the hanger bracket 71 and wire connectors 91,92,93. Alternatively, the installer will push the bare household ground wire 976 into a plug-fit hole 87A of wire connector 91 wherein it is clamped by the interior metal conductor 101 within wire connector 91 to include an additional clamping location 104 in lieu of using a ground screw. After connecting the ground wire the installer then pushes the properly stripped household neutral lead 97N into the plug-fit hole 86 followed by pushing the properly stripped household hot lead 97H into the plug fit hole 89. Now that the household wires are connected to the respective wire connectors the hanger bracket assembly remains fully supported by the household wires allowing the installer to rest and lower his arms prior the next step. The installer now uses the fastening screws 10 to secure the hanger bracket assembly, which includes the wire connectors, to the electrical box 1 wherein he can gently and cautiously bend the household wires 976, 97H, 97N which he can now readily see, to fit into the electrical box 1. With this first step completed the installer will descend the ladder.

The installer now collects the light fixture, such as a chandelier, which includes a support configuration, such as a chain, specific to the light fixture. The efficient installer will have already measured the proper length of the support configuration, such as a chain, and cut it to length while on the floor. Additionally he would have threaded the stranded wire (e.g. 12) through the chain or secured the stranded wire to the support configuration consistent with the design of the light fixture. He would have also slid a finishing nut (similar to that shown as element 8 in FIG. 1) which threads onto the trim screw (similar to that shown as element 13 in FIG. 1) down the chain (6; or equivalent supporting element custom to the fixture) followed by the trim plate (similar to that shown as element 11 in FIG. 1) in preparation of carrying the entire assembly up the ladder. Unlike the prior art, the installer while on the ground will complete most of the steps since he has the coarse adjustment post 72 at ground level. In the prior art the hanger screw 9 was already threaded onto the ceiling bracket as shown in FIG. 1 and the installer used an open chain link 6 to hang the entire assembly onto the solid loop portion 7 of the trim screw 13 which was threaded onto the hanger screw 9. That entire step is now performed totally on the ground in the instant invention since the coarse adjustment post 72 is not attached to the hanger bracket 71 on the ceiling but is in the hand of the installer on the ground.

While on the ground the installer is going to thread the trim screw 13 onto the fine adjustment portion 85 of the coarse adjustment post 72 as shown in FIG. 19. In the instant invention the efficient installer is then going to open the chain link and attach it to the loop 7. But unlike the prior art, while still on the ground the installer bends the open link back to its original shape such that it is permanently secured to the loop 7 of the trim screw 13. Unlike the prior art the installer will not need to bend an open chain link back into its original shape while atop the ladder with both hangs above his head and carrying two pairs of pliers in his tool belt. In fact the final step of the instant invention requires no tools. Instead of opening a chain link the fixture may equivalently come with a substitute link specifically designed to secure the light fixture assembly to the solid loop portion 7 of the trim screw. In either instance, this step is now performed on the ground.

While still on the ground the installer now passes the stranded wire 12 through the hole in the trim screw 13 and then passes the stranded wire 12 through the opening in the fine adjustment portion 85 (as shown in FIG. 19) while the light fixture and chain are resting comfortably on the floor. This leaves the uppermost ends of the stranded wires 95N, 95H, 95G fully accessible to the installer in the open channel 112 of the coarse adjustment post 72. Since with the instant invention the installer knows the exact length of stranded wire needed beyond that of the chain or equivalent support configuration, the stranded wire will be cut and stripped on the ground and thus no longer while atop a ladder as in the prior art. This once again saves time, is safer, and makes it easier with the goal of having the installer performing the least number of tasks while atop the ladder.

The entire light assembly is now fully assembled. The chain or equivalent support element is secured to the loop 7 of the trim screw 13. The trim screw is threaded securely on the fine adjustment portion 85 of the post 72 and the stranded wire 12 is both cut and trimmed of insulation (as shown in FIG. 19). The installer now takes the second and final trip up the ladder. The installer will hold the coarse adjustment post in one hand and support the light fixture and chain in any well known manner. The installer will proceed up the ladder and merely slide the coarse adjustment post 72 through the opening 79 along the angled axis 83 until the previously marked recesses 78 are aligned with the reinforced rail 77 wherein the installer will pivot the post 72 allowing the ramped portion 80 to act as a stop as illustrated in FIG. 8. Now the entire weight of the light assembly is supported by the post 72. The final three steps are for the installer to plug the respective stranded wires 95N, 95G, 95H into the respective plug-in holes 87, 88, 90 followed by raising the trim plate e.g. 11 to the ceiling and lastly to thread the finishing nut 8 onto the threads of the trim screw 13.

If the fixture wire is in the form of thin stranded wire that is too pliable for inserting into the plug-in holes then an added step of connecting adapters (150, 151, 152) to the stranded wire may be performed. It is important to note that this additional step would be performed by the installer on the ground as illustrated by FIG. 19. FIG. 19 shows alternative adapters such as an adapter 150 having a screw for securing the thin stranded wire as well adapters 151, 152 having damping elements or pinching elements to bind the respective stranded wires thereto. Each of the adapters (150, 151, 152) have respective elements 153, 154, 155 which are of proper stiffness and conductivity to provide the proper electrical path of connectivity for each respective lead. It is noted that the adapters 150-152 may have a width A_{W} (shown in FIG. 19) that is wider than the interior diameter F_{W} (FIG. 19; shown by phantom lines) of the fine adjustment portion 85. The adapters will be of a size or dimension that is suitable for comfortable handling by an installer and of such integrity as to insure quality of secure attachment with the respective stranded wires. In addition the connecting elements 153-155 will each be stiff enough for ease of insertion into the respective plug-fit holes yet pliable enough to allow for bending should it be necessary for installation of the trim plate. In each instance this additional step of securing the thin stranded leads to the adapters is performed safely and efficiently on the floor. And since the stranded wires are already passed through the fine adjustment cylindrical portion 85 the installer can readily perform the connection task with ease and safety on the ground. The adapters would provide for proper clamping and thus connectivity with the respective metal strips, wire or conductors in each of the wire connectors. Alternatively, it is understood by one of ordinary skill in the art that the respective wire connectors 91, 92, 93 could be formed with screws (not shown) or clasping elements (not shown) or various equivalents in addition to the lug fit holes 87, 88, 90, or as an alternative to plug-fit holes, to secure thin stranded wire thereto or therein thus avoiding the need for adaptors without departing from the scope of this invention. The installer will have a clear view of the respective plug-fit holes 87, 88, 90 from atop the ladder since they are located on the lowermost surface of each wire connector (FIG. 13). With such a clear view the installer in every instance can gently and cautiously place the fixture wires within the enclosure formed by the trim plate and the ceiling.

With the instant invention the installer is not cutting wires while atop the ladder. The installer does not need to strip wires while atop the ladder. The installer does not need to pull wires up and over a hollow, and possibly sharp hollow hanger screw. The installer does not need to reach into the electrical box to pull out the household wires. The installer does not need to twist the fixture wires with the household wires and apply wire nuts and electrical tape. The installer does not need to bring any tools up the ladder. The building owner does not need to worry about overstuffed electrical boxes causing heat build-up. The building owner does not need to worry about the insulation of the wires being accidentally damaged. And the installer will spend much less time with his hands outstretched above his head while atop the ladder.

What is claimed is:

1. A hanger bracket apparatus comprising:
a hanger bracket, said hanger bracket including an opening,
said opening including an edge,
a stop surface spaced from said hanger bracket and connected thereto, said stop surface functioning such that a post pivoting on said edge is prevented from further pivoting by engagement with sit stop surface.

2. The hanger bracket apparatus of claim 1 comprising:
a post,
said hangar bracket having a substantially planar bottom surface,
said hangar bracket configured to allow the post to slide through said opening at an acute angle to said planar bottom surface.

3. The hanger bracket of claim 2 comprising:
a stop structure extending along one side of said opening,
a reinforcement member extending along said opening along a second side opposite said first side,
said reinforcement member including arcuate surfaces.

4. A wire connector apparatus comprising:
a housing made at least in part of an electrically insulative material,
said housing enclosing at least a portion of a conductor,
said housing having a first opening,
said conductor extending from proximate said first opening forming a first electrical path,
a portion of said conductor extending outside said housing and in connection with said first path.

5. A wire connector apparatus according to claim 4 comprising;
said housing having a second opening,
said conductor extending to proximate said second opening.

6. A wire connector apparatus according to claim 4 comprising;
said housing having an inner surface configured to mimic at least two outer surfaces of a bracket onto which said wire connector is secured.

7. A wire connector apparatus according to claim 5 comprising;
said first opening and said second opening define respective first and second external conductor insert locations,
clamping locations within said wire connector for retaining said first and second external conductors.

8. An wire connection apparatus comprising:
a bracket,
said bracket having outer surfaces including top surface, a side surface and a bottom surface,
wire connector formed at leaser part of an electrically insulative housing,
said wire connector having at least two inner surfaces such that said two inner surfaces of said wire connector are in juxtaposition to at least two of said outer surfaces including said top surface, said side surface or said bottom surface,
said wire connector including an electrical conductor within said housing.

9. The wire connection apparatus of claim 8 comprising;
said wire connector configured such that it can slide along a longitudinal length of said bracket while maintaining said juxtaposition.

10. The wire connection apparatus of claim 8 comprising;
said juxtaposition of said surfaces are configured to prevent rotation of said wire connector relative to said bracket.

11. An apparatus comprising:
a post,
said post coarse adjustment portion and a fine adjustment portion,
said coarse adjustment portion having an open side and at least two spaced recesses providing said coarse adjustment,
said fine adjustment portion having exterior threads, paid exterior threads providing said fine adjustment.

12. An apparatus of claim 11 comprising;
said post having a longitudinal axis,
said exterior threads having a thread pitch along said longitudinal axis,
said at least two spaced recesses being spaced along said longitudinal axis at a greater distance than said thread pitch.

13. An apparatus comprising;
an elongated bracket having an opening and a substantially planar bottom surface,
a stop surface space from said elongated bracket and connected thereto,
a post,
said elongated bracket configured to allow said post to slide through said opening at an acute angle to said substantially planar bottom surface,
said elongated bracket and opening further configured to allow said post to rotate,
said stop surface limiting the angle of rotation of said post.

14. The apparatus of claim 13 comprising;
said opening including a ledge,
said post including at least one recess,
said ledge being receivable in said recess,
said post being rotatable about said ledge.

15. An apparatus of claim 14 comprising;
said ledge including an arcuate surface.

16. The apparatus of claim 13 comprising;
said elongated bracket having outer surfaces including a top surface, a side surface and said substantially planar bottom surface,
a wire connector,
said wire connector having at least two inner surfaces such that said two inner surfaces of said wire connector are in juxtaposition to at least two of said outer surfaces including said top surface, said side surface or said substantially planar bottom surface,
said wire connector including an electrical conductor therein.

17. The apparatus of claim 16 including;
said wire connector is configured to slid along said elongated bracket while maintaining said juxtaposition.

18. The apparatus of claim 13 including;
said post having a coarse adjustment portion and a fine adjustment portion,
said coarse adjustment portion having an open side and at least two recesses spaced from each other providing said coarse adjustment,
said fine adjustment portion having exterior threads, said exterior threads providing said fine adjustment.

19. An apparatus of claim 13 comprising;
said elongated bracket having a substantially planar top surface on the same side of the bracket as the stop surface.

20. An apparatus of claim 19 comprising;
a wire connector,
said wire connector formed at least in part of an electrically insulative housing,
said wire connector having at least surface in juxtaposition to said substantially planar top surface,
an electrical conductor encased in said electrical insulative housing and having a portion extending external thereto,
said external portion of said electrical conductor in contact with said elongated bracket.
